(19) United States
(12) Patent Application Publication
(10) Pub. No.: US 2004/0148364 A1
(43) Pub. Date: Jul. 29, 2004

(54) Methods of transmitting binding update message and binding acknowledgement message

(75) Inventors: Pyung-Soo Kim, Seoul (KR); Sun-Woo Kim, Gyeonggi-do (KR); Hak-Goo Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/717,607

(22) Filed: Nov. 21, 2003

(30) Foreign Application Priority Data
Dec. 17, 2002 (KR) 2002-80877

(51) Int. Cl. G06F 15/16

(52) U.S. Cl. 709/217

(57) ABSTRACT

A method of transmitting a binding update (BU) message, a method of transmitting a binding acknowledgement (BACK) message, the structure of the BU message, the structure of the BACK message, a mobile node that performs BU, and a home agent that performs BU. The method of transmitting a binding update (BU) message contains an identifier that indicates whether there is a request for slave home agent information, in a mobile IPv6 environment. Here, the slave home agent information is information on a slave home agent which neighbors a master home agent that receives the BU message.

### CROSS-REFERENCE TO RELATED APPLICATIONS

This application claims the priority of Korean Patent Application No. 2002-80877, which was filed on Dec. 17, 2002, in the Korean Intellectual Property Office, the disclosure of which is incorporated herein in its entirety by reference.

### BACKGROUND OF THE INVENTION

1. Field of the Invention

The present invention relates to a binding update in a mobile IPv6 environment, and, more particularly, to a method of transmitting a binding update message, a method of transmitting a binding acknowledgement message, the structure of the binding update message, the structure of the binding acknowledgement message, a mobile node that performs binding update, and a home agent that performs binding update.

2. Description of the Related Art

A mobile node in a mobile IPv6 environment is always addressable with its address, regardless of whether the mobile node is attached to its home link or not. Here, the home address is an IP addresses allotted to the mobile node within a home sub-net prefix on the home link of the mobile node.

While a mobile node is at home, packets addressed to the home address of the mobile node are routed to the home link of the mobile node using conventional Internet routing mechanisms. If the mobile node is attached to a foreign link, which is distant from the home link of the mobile node, it is also addressable with one or more care-of-addresses. A care-of-address is an IP address that is associated with a mobile node and that has a specific foreign link subnet prefix. A mobile node can obtain a care-of-address through conventional IPv6 automatic configuration mechanisms. While a mobile node is visiting a specific foreign link, packets addressed to the care-of-address of the mobile node are routed to the mobile node at the foreign link.

A process of associating the home address of a mobile node with the care-of-address of the mobile node is called mobile node binding. While the mobile node is distant from its home link, it registers its primary care-of-address in a router on its home link, and the router serves as a home agent for the mobile node. The mobile node can carry out binding by sending a binding update (BU) message to the home agent. Then the home agent responds to the reception of the BU message by sending a binding acknowledgement (BACK) message to the mobile node. The BU message and the BACK message are transmitted to their respective destinations via an expansion header of an IPv6 packet.

Recently, a mobile IPv6 standardization document, devoted to a protocol named ‘home agent address discovery,’ has been released. The home agent address discovery protocol supports reconstitution of a plurality of home agents on a home network. For some reason, a mobile node may not be able to figure out the IP address of its own home agent, or the home subnet prefix of the mobile node may vary in accordance with the passage of time. A ‘dynamic home agent address discovery’ mechanism makes it possible for even a mobile node that is distant from home to dynamically discover the IP address of a corresponding home agent on a home link.

In other words, a home agent pursues other home agents on its link and keeps such information as a list of all the other home agents on its link. This home agents list is used for the dynamic home agent address discovery mechanism.

Dynamic home agent address discovery is initiated by a mobile node sending a home agent address discovery request message to a home agent. The home agent, which receives the home agent address discovery request message, attempts to carry out dynamic home agent address discovery. Thereafter, the home agent sends a home agent address discovery reply message to the mobile node.

Conventional home agent address discovery will be described more fully with reference to FIGS. 1 and 2, which are a diagram and a flowchart illustrating conventional home agent address discovery.

A mobile node 140 accesses a home link and receives a home address, which will not be changed, from a home agent (i.e., a master home agent) 110. When the mobile node 140 leaves the home link and accesses an external link, it receives a new temporary address, i.e., a care-of-address. As soon as the mobile node 140 receives the care-of-address, it sends a BU message to the master home agent 110 in operation S210 in order to inform the master home agent 110 of the mobile node 140's reception of the care-of-address. The master home agent 110, which receives the BU message from the mobile node 140, sends a BACK message to the mobile node 140 in operation S220. The mobile node 140 works together with the master home agent 110 to periodically carry out the above-described binding update or binding acknowledgement process.

At some point during this process, the master home agent 110 may not operate for some reason, in which case the mobile node 140 may not be able to receive a binding acknowledgement. At that moment, the mobile node 140 executes the home agent address discovery protocol in order to gain a new home address.

In operation S230, the mobile node 140 anycasts a home agent address discovery request message to a home agent prefix of the same home link to which the master home agent 110 belongs.

Then, in operation S240, a predetermined home agent that receives the home agent address discovery request message from the mobile node 140 sends a home agent address discovery reply message to the mobile node 140 together with a home agent list, including the unicast addresses of the predetermined home agent and its neighboring home agents.

In operation S250, the mobile node 140 selects a new home agent address taking priority levels of all the home agent addresses into account. In general, the mobile node 140 is supposed to select a home agent address of top priority. Afterwards, the mobile node 140 works together with a new master home agent 120 to periodically carry out the above-mentioned binding update or binding acknowledgement process.

FIG. 3 is a diagram illustrating the structure of a conventional home agent address discovery request message. The home agent address discovery request message is used for a mobile node to initiate a dynamic home agent address discovery mechanism.

Referring to FIG. 3, a home agent address discovery request message 300 includes a type field 310, a code field 320, a checksum field 330, a home agent address request identification field 340, and a reserved field 350. The identification field 340 is provided for matching the home agent address discovery request message 300 with a home agent address discovery reply message and indicates that the home agent address discovery request message 300 demands home agent address discovery.

FIG. 4 is a diagram illustrating the structure of a conventional home agent address reply message. The home agent address discovery reply message is used for a home agent to respond to a mobile node that uses a dynamic home agent address discovery mechanism.

Referring to FIG. 4, a home agent address discovery reply message 400 includes a type field 410, a code field 420, a checksum field 430, an identification field 440, which is invoked by a home agent address request message, a reserved field 450, and a home agent address field 460. The home agent address field 460 includes a list of the addresses of home agents on a home link.

FIG. 5 is a diagram illustrating the structure of a conventional BU message. The BU message is used for a mobile node to inform its home agent of its new care-of-address.

Referring to FIG. 5, a BU message 500 includes a sequence number field 510, an acknowledgement field 520, a home registration field 530, a single-address-only field 540, a duplicate address detection field 550, a link local address compatibility field 560, a reserved field 570, a lifetime field 580, and a mobility option field 590. The lifetime field 580 indicates the number of time units before binding is complete. A single time unit lasts for four seconds.

FIG. 6 is a diagram illustrating the structure of a conventional BACK message. The BACK message is used for a home agent to inform a mobile node of its reception of a BU message.

Referring to FIG. 6, a BACK message 600 includes a status field 610, a reserved field 620, a sequence number field 630, a lifetime field 640, and a mobility option field 650.

The status field 610 is represented by a non-signed 8-bit integer, which indicates the characteristics of a BU message. More specifically, when the status field 610 is represented by a value that is smaller than 128, it indicates that the BU message has been accepted by a receiving node. On the contrary, when the status field 610 is represented by a value that is not smaller than 128, it indicates that the BU message has been rejected by the receiving node. For example, when the status field 610 is represented by a value of 0, it indicates that it indicates that the BU message has been accepted by a receiving node.

The sequence number field 630 of the BACK message 600 is a copy of a sequence number field 510 of the BU message and is provided for matching the BU message with the BACK message 600.

As described above, in the prior art, home agent address discovery is carried out separately from a binding process, which may cause communications traffic to increase.

### SUMMARY OF THE INVENTION

Accordingly, it is an aspect of the present invention to provide a method of transmitting a binding update (BU) message, containing an identifier that indicates whether or not there is a request for slave home agent information, in a mobile IPv6 environment. Here, the slave home agent information is information on a slave home agent which neighbors a master home agent that receives the BU message.

It is another aspect of the present invention to provide a method of transmitting a binding acknowledgement (BACK) message, containing slave home agent information, in a mobile IPv6 environment.

It is another aspect of the present invention to provide a BU message in a mobile IPv6 environment, containing an identifier that indicates whether or not there is a request for slave home agent information. Here, the slave home agent information is information on a slave home agent which neighbors a master home agent that receives the BU message.

It is another aspect of the present invention to provide a BACK message in a mobile IPv6 environment, containing slave home agent information.

It is another aspect of the present invention to provide a mobile node that carries out binding update in a mobile IPv6 environment. The mobile node includes a BU message transmission unit which transmits a BU message, containing an identifier that indicates whether or not there is a request for slave home agent information, to a master home agent; a BACK message reception unit which receives a BACK message, containing the slave home agent information, from the master home agent; and a slave home agent information storing unit which stores the slave home agent information contained in the BACK message. Here, if the BACK message has not been received from the master home agent at a predetermined moment of time, the BU message transmission unit transmits the BU message to a new master home agent using the slave home agent information stored in the slave home agent information storing unit.

It, is another aspect of the present invention to provide a home agent that carries out binding update in a mobile IPv6 environment. The home agent includes a BU message reception unit which receives a BU message, containing an identifier that indicates whether or not there is a request for slave home agent information, from a mobile node; a slave home agent information transmission determination unit which determines whether to transmit the slave home agent information, requested by the mobile node, to the mobile node or not; a BACK message generation unit which generates a BACK message, containing the slave home agent information, if the slave home agent information transmission determination unit determines to transmit the slave home agent information, and generates an ordinary BACK message if the slave home agent information transmission determination unit determines not to transmit the slave home agent information; and a BACK message transmission unit which transmits the BACK message created by the BACK message generation unit to the mobile node.

Additional aspects and/or advantages of the present invention will be set forth in part in the description that follows, and, in part, will be obvious from the description, or may be learned by practicing the present invention.

The foregoing and/or other aspects and/or advantages of the present invention are achieved by providing methods of transmitting a binding update (BU) message and a binding acknowledgement (BACK) message in a mobile IPv6 environment, the structure of the BU message, the structure of the BACK message, a mobile node that performs binding update, and a home agent that performs binding update so as to reduce communications traffic.

### BRIEF DESCRIPTION OF THE DRAWINGS

These and/or other aspects and/or advantages of the present invention will become more apparent and more readily appreciated by describing in detail embodiments thereof with reference to the attached drawings of which:

FIG. 1 is a diagram illustrating conventional home agent address discovery;

FIG. 2 is a flowchart of conventional home agent address discovery;

FIG. 3 is a diagram illustrating the structure of a conventional home agent address discovery request message;

FIG. 4 is a diagram illustrating the structure of a conventional home agent address reply message;

FIG. 5 is a diagram illustrating the structure of a conventional binding update (BU) message;

FIG. 6 is a diagram illustrating the structure of a conventional binding acknowledgement (BACK) message;

FIGS. 7 and 8 are diagrams illustrating home agent address discovery according to an embodiment of the present invention;

FIG. 9 is a flowchart of home agent address discovery according to an embodiment of the present invention;

FIG. 10 is a diagram illustrating the structure of a BU message according to an embodiment of the present invention;

FIG. 11 is a diagram illustrating the structure of a BACK message according to an embodiment of the present invention;

FIG. 12 is a block diagram of a home agent that performs a binding update or binding acknowledgement process according to an embodiment of the present invention; and

FIG. 13 is a block diagram of a mobile node that performs a binding update or binding acknowledgement process according to an embodiment of the present invention.

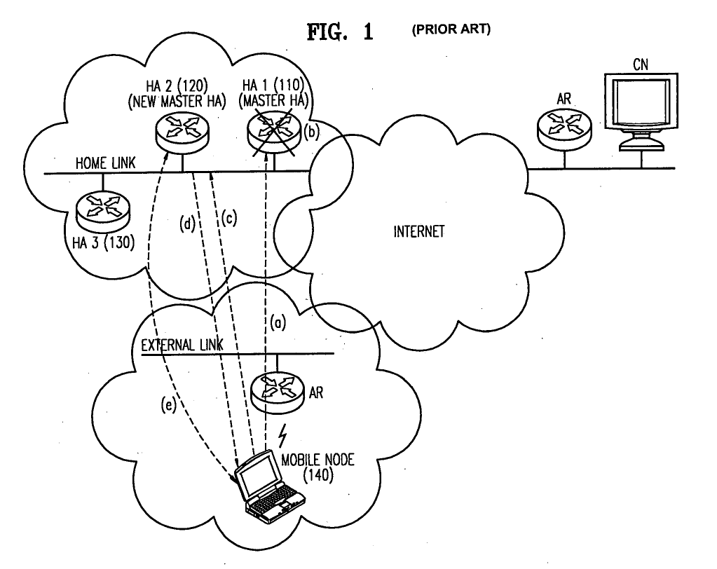

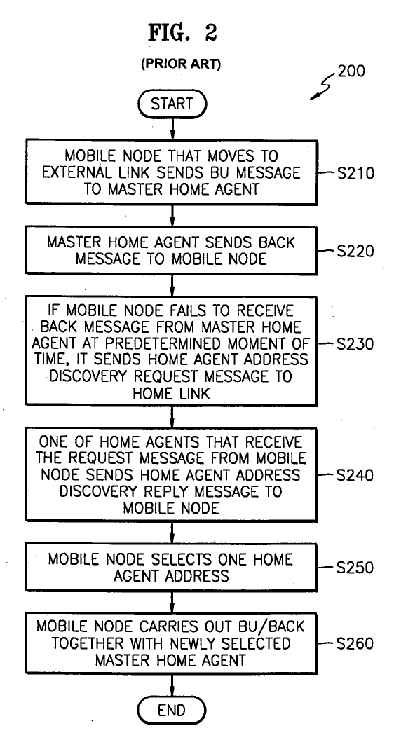

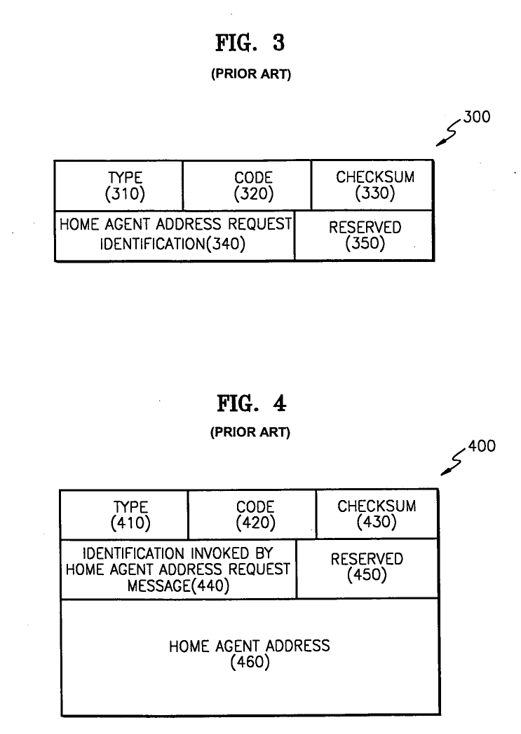

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

In order to reduce unnecessary communications traffic, the present invention suggests that the transmission of a home agent address discovery request message and a home agent address discovery reply message be carried out during the transmission of a BU message and a BACK message between a mobile node and a master home agent.

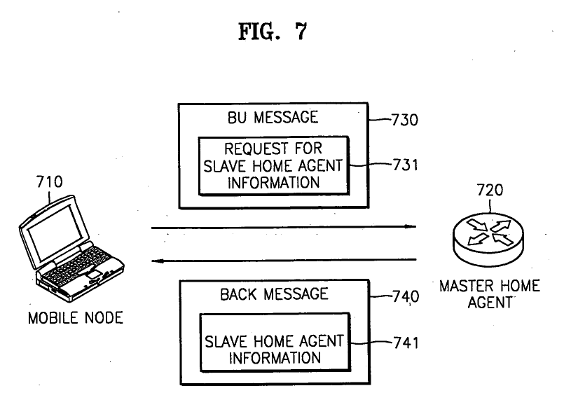

FIG. 7 is a diagram illustrating home agent address discovery according to an embodiment of the present invention. As shown in FIG. 7, a mobile node 710 inserts a slave home agent address information request 731 into a binding update (BU) message 730 and sends the resulting BU message 730 to a master home agent 720. Then, the master home agent 720 inserts slave home agent information 741 into a binding acknowledgement (BACK) message 740 and sends the resulting BACK message 740 to the mobile node 710 in response to the reception of the BU message 730 (hereinafter, a series of processes of transmitting a BU message from the mobile node 710 to the master home agent 720 and transmitting a BACK message from the master home agent 720 to the mobile node 710 are called a BU/BACK operation). Therefore, even in a case where the mobile node 710 fails to receive a BACK message from the master home agent 720 at a predetermined moment of time during the BU/BACK operation, it does not need to transmit a home agent address discovery request message to the master home agent 720. Rather, the mobile node 710 can send a BU message to the master home agent 720 by simply using previous slave home agent information that has been received from the mobile home agent 720. Here, the slave home agent information 741 is information on a slave home agent, which neighbors the master home agent 720 that receives the BU message.

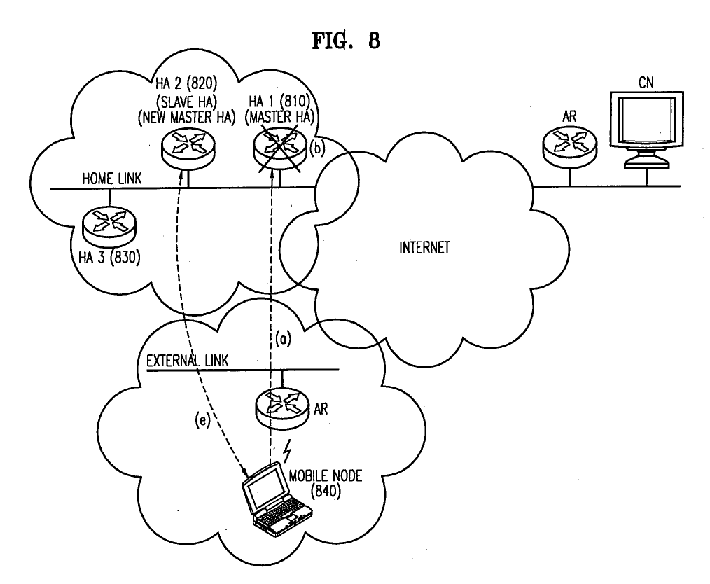

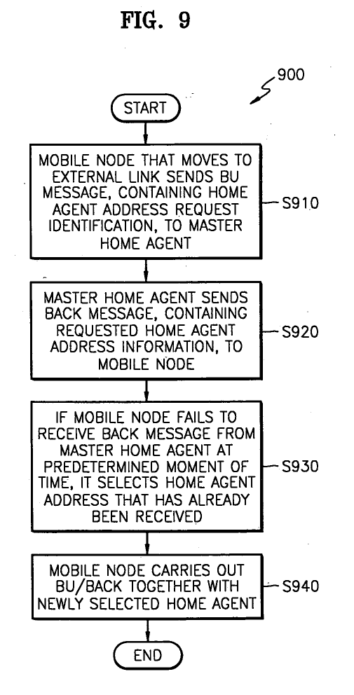

A BU/BACK operation, involving home agent address discovery, according to an embodiment of the present invention, will be described in the following paragraphs with reference to FIGS. 8 and 9.

When a mobile node 840 moves from its home link to an external link, it receives a new care-of-address. Then, the mobile node 840 sends a BU message, including a home agent address request identification field, to a master home agent 810 in operation S910.

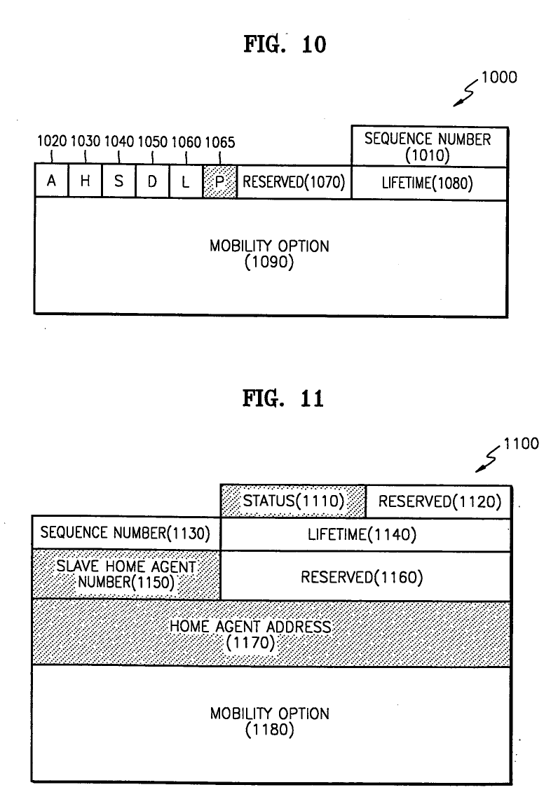

An example of the BU message, including a newly defined home agent address request identification field, is illustrated in FIG. 10.

Referring to FIG. 10, a BU message 1000 includes a sequence number field 1010, an ‘A’ field 1020, an ‘H’ field 1030, an ‘S’ field 1040, a ‘D’ field 1050, an ‘L’ field 1060, a ‘P’ field 1065, a reserved field 1070, a lifetime field 1080, and a mobility option field 1090.

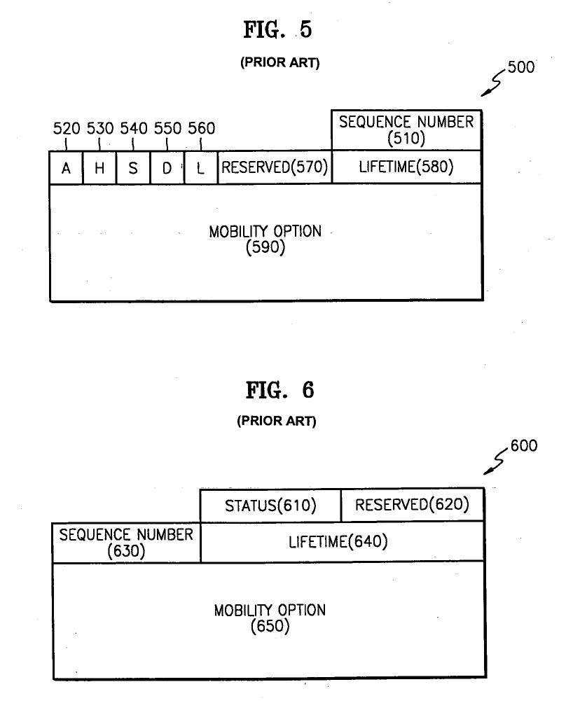

The BU message 1000 of FIG. 10 includes the same elements as the conventional BU message 500 of FIG. 5 except for the ‘P’ field 1065.

The BU message 1000, according to an embodiment of the present invention, defines part of the reserved field 570 of the conventional BU message 500 as the ‘P’ field (flag) 1065. The ‘P’ field 1065 indicates whether or not a mobile node wants to obtain slave home agent information. In other words, when the ‘P’ field 1065 is set to a value of 1, it indicates that the mobile node wants to obtain the slave home agent information. When the ‘P’ field 1065 is set to a value of 0, it indicates that the mobile node does not want to obtain the slave home agent information. Even in a case where the mobile node has already obtained the slave home agent information in a first round of a BU/BACK operation, the ‘P’ field 1065 may also be set to a value of 0. However, embodiments of the present invention are not limited to using only the values of 1 and 0, as any other values may be used.

The BU message, including a slave home agent information request identification field, according to an embodiment of the present invention, may be used in the first round of the BU operation performed by the mobile node because once the slave home agent information is obtained in the first round of the BU operation, the mobile node does not need to attempt to obtain the slave home agent information again in later rounds of the BU operation. If the mobile node tries to obtain the slave home agent information in each round of the BU operation, a considerable amount of traffic will be required for sending a BACK message.

Thereafter, in operation S920, the master home agent 810 sends a BACK message, containing the requested slave home agent information, to the mobile node 840 in response to the reception of the BU message.

An example of the BACK message, containing the slave home agent information, is illustrated in FIG. 11.

Referring to FIG. 11, a BACK message 1100 includes a status field 1110, a reserved field 1120, a sequence number field 1130, a lifetime field 1140, a number-of-slave home agents field 1150, a reserved field 1160, a home agent address field 1170, and a mobility option field 1180.

The BACK message 1100 includes the same elements as the conventional BACK message 600 of FIG. 6 except for the status field 1110, the number-of-slave home agents field 1150, and the home agent address field 1170.

The status field 1110 indicates whether the master home agent 830 will transmit slave home agent information to the mobile node 840 that has sent a BU message. For example, when the status field 1110 is set to a value of “0”, it indicates that the BU message has been successfully transmitted to the master home agent 830 but the master home agent 830 will not transmit the slave home agent information to the mobile node 840 in return. When the status field 1110 is set to a value of “100”, it indicates that the BU message has been successfully transmitted to the master home agent 830 and the master home agent 830 will transmit the slave home agent information to the mobile node 840 in response to the reception of the BU message. The status field 1110 may be set to values other than 0 and 100, of course.

The number-of-slave home agents field 1150 represents the number of slave home agents of higher priority levels, which is to be transmitted using the BACK message 1100. The number-of-slave home agents field 1150 is set to a default value of “1” because the number of slave home agents of a high priority level is at least 1.

The home agent address field 1170 represents the addresses of slave home agents that are arranged in a predetermined order according to their priority levels.

In other words, in a case where the BU message has been successfully transmitted to the master home agent 830 but the master home agent 830 will not transmit the slave home agent information to the mobile node 840 in return, the master home agent 830 sends the BACK message 1100 with the status field 1110 set to 0. In a case where the BU message has been successfully transmitted to the master home agent 830 and the master home agent 830 will transmit the slave home agent information in response to the reception of the BU message, the master home agent 830 sends the BACK message 1100, containing information on one or more slave home agents of higher priority levels, i.e., the number-of-slave home agents field 1150 and the slave home agent address field 1170, to the mobile node 840 with the status field 1110 set to 100. Thereafter, the master home agent 830 and the mobile node 840 carry out the BU/BACK operation in a conventional manner.

In some cases, the master home agent 830 may not be able to operate because it is out of order or being repaired or because of system reconfiguration. When the master home agent 830 does not operate, the mobile node 840 cannot receive a BACK message from the master home agent 830.

In operation S930, the mobile node 840 selects a new home agent address in consideration of the priority levels of slave home agents, specified in the slave home agent address information that it has already obtained.

Thereafter, the mobile node 840 works together with a new master home agent 820 to carry out a BU/BACK operation in operation S940. The mobile node 840 obtains slave home agent information from the new master home agent 820 by sending a BU message, containing a slave home agent information request, to the new master home agent 820 in a first round of a BU/BACK operation.

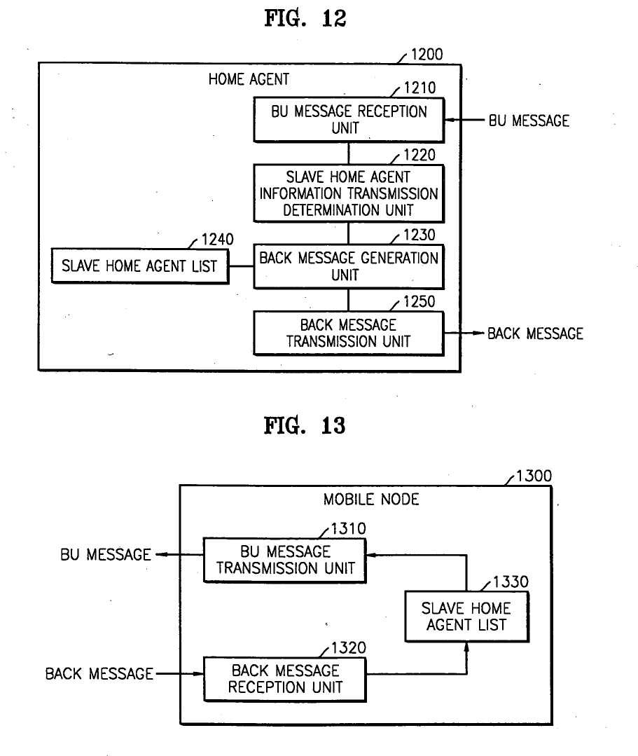

FIG. 12 is a block diagram of a home agent that carries out a BU/BACK operation according to an embodiment of the present invention.

Referring to FIG. 12, a home agent 1200 includes a BU message reception unit 1210, a slave home agent information transmission determination unit 1220, a BACK message generation unit 1230, a slave home agent list 1240, and a BACK message transmission unit 1250.

The binding update message reception unit 1210 receives and interprets a BU message. If a slave home agent information request identification field is included in the BU message, the slave home agent information transmission determination unit 1220 determines whether to transmit slave home agent information.

If the slave home agent information transmission determination unit 1220 determines to transmit the slave home agent information, the BACK message generation unit 1230 creates a BACK message and inserts the slave home agent information into the BACK message. Otherwise, the BACK message generation unit 1230 creates the BACK message without inserting the slave home agent information into the BACK message. The slave home agent information inserted into the BACK message may be information on a single slave home agent of a high priority level among a plurality of slave home agents on the slave home agent list.

Thereafter, the BACK message transmission unit 1250 transmits the created BACK message to a mobile node that has transmitted the BU message thereto.

FIG. 13 is a block diagram of a mobile node that performs a BU/BACK operation according to an embodiment of the present invention.

Referring to FIG. 13, a mobile node 1300 includes a BU message transmission unit 1310, a BACK message reception unit 1320, and a slave home agent list storing unit 1330.

The BU message transmission unit 1310 transmits a BU message, including a slave home agent information request identification field, to a master home agent. The BACK message reception unit 1320 receives a BACK message from the master home agent as a way of confirmation that the BU message has been successfully transmitted to the master home agent. In a case where slave home agent information is contained in the received BACK message, the slave home agent information is stored in the slave home agent list storing unit 1330.

If the mobile node 1300 fails to receive the BACK message from the master home agent for some reason while periodically carrying out a BUIBACK operation together with the master home agent, the mobile node 1300 selects the address of a slave home agent of a high priority level among the addresses of slave home agents stored in the slave home agent list storing unit 1330. Thereafter, the mobile node 1300 sends a new BU message to the selected slave home agent. The mobile node 1300 sends the BU message to the selected slave home agent together with a slave home agent information request identification field because it is a first round of a BU/BACK operation carried out by the mobile node 1300 and the selected slave home agent.

As described above, according to the present invention, it is possible to obtain slave home agent information during a BU/BACK operation. Therefore, processes of issuing a request for home agent address discovery and responding to the request can be omitted, and thus unnecessary communication traffic can be removed. These advantages, in particular, could become more apparent when there are many mobile nodes that periodically carry out a BU/BACK operation together with home agents.

In addition, in the present invention, information on only a few slave home agents of higher priority levels is contained in a BACK message. Therefore, a protocol according to the present invention is more efficient than conventional protocols, in which the BACK message is required to include information on all home agents.

Furthermore, the present invention can realize more flexible protocols because the protocol according to the present invention allows such conventional protocols to be realized thereon.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising:
transmitting a binding update (BU) message, containing an identifier that indicates whether there is a request for slave home agent information, to a master home agent, in a mobile IPv6 environment,
wherein the slave home agent information is information on a slave home agent that neighbors the master home agent.

2. The method of claim 1, wherein when the identifier is set to “1”, the identifier indicates that there is a request for the slave home agent information, and when the identifier is set to “0”, the identifier indicates that there is no request for the slave home agent information.

3. The method of claim 2, wherein the BU message is transmitted in a first round of a binding update/binding acknowledgement (BU/BACK) operation.

4. A method comprising:
transmitting a binding acknowledgement (BACK) message, containing slave home agent information, to a mobile node, in a mobile IPv6 environment.

5. The method of claim 4, wherein the slave home agent information comprises:
an identifier that indicates whether the slave home agent information will be transmitted;
the number of slave home agents; and
at least one slave home agent address.

6. The method of claim 5, wherein when the identifier is set to “0”, the identifier indicates that the slave home agent information will not be transmitted, and when the identifier is set to a predetermined value other than “0”, the identifier indicates that the slave home agent information will be transmitted.

7. The method of claim 4, wherein the BACK message is transmitted in a first round of a BU/BACK operation.

8. A binding update (BU) message in a mobile IPv6 environment, containing an identifier that indicates whether there is a request for slave home agent information, wherein the slave home agent information is information on a slave home agent that neighbors a master home agent that receives the BU message.

9. The BU message of claim 8, wherein when the identifier is set to “1”, the identifier indicates that there is a request for the slave home agent information, and when the identifier is set to “0”, the identifier indicates that there is no request for the slave home agent information.

10. A binding acknowledgement (BACK) message in a mobile IPv6 environment, containing slave home agent information.

11. The BACK message of claim 10, wherein the slave home agent information comprises:
an identifier that indicates whether the slave home agent information will be transmitted;
a value indicating a number of slave home agents; and
at least one slave home agent address.

12. The BACK message of claim 11, wherein when the identifier is set to “0”, the identifier indicates that the slave home agent information will not be transmitted, and when the identifier is set to a predetermined value other than “0”, the identifier indicates that the slave home agent information will be transmitted.

13. The BACK message of claim 11, wherein slave home agent addresses are arranged in a predetermined order according to their priority levels.

14. A mobile node that carries out binding update (BU) in a mobile IPv6 environment, the mobile node comprising:
a BU message transmission unit that transmits a BU message, containing an identifier that indicates whether there is a request for slave home agent information, to a master home agent;
a binding acknowledgement (BACK) message reception unit that receives a BACK message, containing the slave home agent information, from the master home agent; and
a slave home agent information storing unit that stores the slave home agent information contained in the BACK message,
wherein if the BACK message has not been received from the master home agent at a predetermined moment of time, the BU message transmission unit transmits the BU message to a new master home agent using the slave home agent information stored in the slave home agent information storing unit.

15. A home agent that carries out binding update (BU) in a mobile IPv6 environment, the home agent comprising:
a BU message reception unit that receives a BU message, containing an identifier that indicates whether there is a request for slave home agent information, from a mobile node;
a slave home agent information transmission determination unit that determines whether to transmit the slave home agent information, requested by the mobile node, to the mobile node;
a binding acknowledgement (BACK) message generation unit which generates a BACK message, containing the slave home agent information, if the slave home agent information transmission determination unit determines to transmit the slave home agent information, and generates an ordinary BACK message if the slave home agent information transmission determination unit determines not to transmit the slave home agent information; and
a BACK message transmission unit that transmits the BACK message created by the BACK message generation unit to the mobile node.

16. A method of discovering a home agent address in a mobile IPv6 environment, comprising:
inserting a slave home agent address information request into a first binding update (BU) message; and
transmitting the first BU message to a master home agent.

17. The method of claim 16, further comprising:
upon not receiving a binding acknowledgement (BACK) message from the master home agent at a predetermined time, inserting the slave home agent address information request into a second BU message; and
transmitting the second BU message to a slave home agent,
wherein the slave home agent was identified in a previous BACK message, which included slave home agent information, and which was received from the master home agent in response to a previous BU message that included the slave home agent address information request.

18. The method of claim 16, wherein the first BU message comprises a home agent address request identification field to indicate whether slave home agent information is needed.

19. The method of claim 17, wherein the second BU message comprises a home address request identification field to indicate whether the slave home agent information is needed.

20. The method of claim 16, further comprising:
receiving a binding acknowledgement (BACK) message from the master home agent.

21. The method of claim 20, wherein the BACK message comprises a status field to indicate whether slave home agent information is included.

22. The method of claim 21,
wherein the BACK message comprises slave home agent information when the status field indicates that the slave home agent information is included, and
wherein the BACK message does not comprise slave home agent information when the status field indicates that the slave home agent information is not included.

23. The method of claim 22, wherein the BACK message comprises a number-of-slave home agents field to indicate a number of candidate slave home agents of higher priority levels.

24. The method of claim 23,
wherein the number-of-slave home agents field includes the number of candidate slave home agents of higher priority levels when the status field indicates that the slave home agent information is included, and
wherein the number-of-slave home agents field does not include the number of candidate slave home agents of higher priority levels when the status field indicates that the slave home agent information is not included.

25. The method of claim 23, wherein the BACK message further comprises a home agent address field to indicate addresses of the candidate slave home agents, which are arranged in a predetermined order according to corresponding priority levels.

26. The method of claim 25,
wherein the home agent address field includes the addresses of the candidate slave home agents when the status field indicates that the slave home agent information is included, and
wherein the home agent address field does not include the addresses of the candidate slave home agents when the status field indicates that the slave home agent information is not included.

27. The method of claim 25, further comprising:
selecting the slave home agent based on the priority levels of the candidate slave home agents.
